(19) United States
(12) Patent Application Publication
(10) Pub. No.: US 2018/0135899 A1
(43) Pub. Date: May 17, 2018

(54) AN IMPROVED TEMPERATURE CONTROL SYSTEM

(71) Applicant: David Turner, Lancashire (GB)

(72) Inventor: David Turner, Lancashire (GB)

(21) Appl. No.: 15/572,438

(22) PCT Filed: May 6, 2016
(86) PCT No.: PCT/GB2016/051289

§ 371 Date: Nov. 7, 2017

(30) Foreign Application Priority Data
May 7, 2015 (GB) 1507798.5
Sep. 29, 2015 (GB) 1517161.4

(51) Int. Cl. F25B 27/00; F25B 5/02; F25B 6/02; F25B 27/02; F25B 30/02; F25B 49/02; F25B 41/04

(52) U.S. Cl. CPC F25B 27/005; F25B 5/02; F25B 6/02; F25B 41/046; F25B 30/02; F25B 49/022; F25B 27/02

(57) ABSTRACT

Temperature control system and method A temperature control system (10) includes a compressor (1), a condenser (4), an expansion valve (5), and an evaporator (60 all connected in series. At least one heat exchanger (3) is located between the compressor and the condenser and operable to transfer heat energy from an external heat source to the refrigerant. In one variant, an array of heat exchangers is located between the compressor and the condenser. In a further variant (210, FIG. 3), there are one or more heat exchangers located between the compressor and the condenser and flow control means to direct the flow of refrigerant either through at least one heat exchanger or directly from the compressor to the condenser bypassing at least one of the heat exchangers. Methods of heating and cooling an environment using the system are also disclosed.

### TECHNICAL FIELD OF THE INVENTION

The present invention relates to cooling and heating systems such as air-conditioning units and refrigerators, and in particular, to improvements in cooling and heating systems which operate using a compression cycle.

### BACKGROUND TO THE INVENTION

Temperature control systems, such as air-conditioning, cooling and refrigeration systems commonly use a compression cycle to either heat or cool their surroundings through respective cooling or heating of a fluid refrigerant. Generally, the refrigerant fluid is initially a gas which is compressed by a compressor, subsequently liquefied in a condenser and then injected through an expansion valve. The injection of the highly pressurised, liquid refrigerant through the expansion valve allows the refrigerant to expand rapidly. The refrigerant is then passed through an evaporator in which the refrigerant absorbs heat energy from surrounding air or other fluids which are passed about the evaporator thereby cooling them. This process may run in reverse in order to heat surroundings, whereby hot pressurised refrigerant is passed through the evaporator and the surrounding air or fluids passing over the evaporator absorb this heat.

As the refrigerant is preferably a gaseous fluid, its physical state may be approximated using the ideal gas law which states:

pV=nRT [Equation 1]

where p is the pressure of the gas in Pascals, V is the volume of the gas in m³, n is the number of molecules of the gas present within the volume V, R is the molar gas constant (approximately equal to 8.31 m² kg s⁻² K⁻¹ mol⁻¹) and T is the temperature of the gas in Kelvin.

Essentially, Equation 1 tells us that the product of the pressure of the gas and the volume within which the gas is contained is proportional to the product of the number of molecules of gas present and the temperature of the gas. In effect, in environments wherein the volume remains constant, such as in the refrigerant pipes of a temperature control system, an increase in temperature may have two effects depending on the opening of the subsequent expansion valve. When the valve is closed, no molecules of the gas may leave and both the volume and the pressure of the refrigerant increases. When the expansion valve is opened, the molecules of the gas pass rapidly through the opening of the valve leaving the pressure of the gas virtually unchanged. As the pressure behind the expansion valve is much lower than prior, the gas will have a higher tendency to leave through the opening of the valves instead of building up a pressure ahead of the expansion valve. The effect of heating the gas enhances the number of molecules being pushed through the valve thus creating a higher mass flow at the evaporator, therefore increasing the cooling capacity in the evaporator. The controls of the system react to the increase by reducing the mass flow of the compressor to re-achieve the original targeted cooling capacity. Both effects, the pressure increase and mass flow increase, reduce the electrical consumption of the compressor. The rate of which depends on the very specific situation; if and how much the expansion valve is opened at the operation.

Temperature control units of this type generally require a vast amount of energy to operate and it is therefore desirable to be able to reduce the energy consumption of such systems. The compressor is generally the component which consumes the most energy during operation of a temperature control system. In some cases, the energy consumed by the compressor may account for up to 80% of the total energy used by the system. For this reason, it is highly desirable for the energy consumption of a compressor in these systems to be reduced.

There are a number of known systems targeted at reducing energy consumption and include systems whereby waste heat energy from the system itself is recovered (see in particular DE000019925477A1). The system described in this document involves recovering heat energy from the motor or control unit which is used to heat up the refrigerant at a desired point in the cycle, in particular, before it enters the compressor. Similarly, WO0155647 describes a system whereby a heat exchanger is placed after the compressor to recover heat escaping from the refrigerant pipes, however, the energy recovered from this results in a loss of temperature in the refrigerant itself.

WO2014146498 and DE102007011014A1 both describe systems wherein the refrigerant is heated by an electrical means before it is passed through the compressor. This reduces the work required to be performed by the compressor to compress the refrigerant by a sufficient amount to increase the pressure as desired. However, the reduction in energy consumption of the compressor is not significant in these systems, and they are primarily employed in environments which have a very low ambient temperature where the refrigerant is generally significantly cooler and could thereby damage the compressor in combination with insufficient oil supply.

WO2011048594 A2 describes an air conditioning system having a compressor unit which incorporates a mechanical compressor and a single thermal collector in the form of a solar panel located downstream of the mechanical compressor to increase the temperature of the refrigerant. Incorporation of the thermal collector as part of a compressor unit together with the mechanical compressor limits the size of the thermal collector and is suitable only for smaller air conditioning systems. The arrangement also requires that the thermal collector is located proximal to the compressor and so has limited flexibility. The system has only very limited control over the amount of heat transferred to the refrigerant through the thermal collector. Furthermore, the system works only with a variable speed DC Inverter mechanical compressor and so is unsuitable for use in temperature control systems with fixed speed compressors.

It is therefore an aim of an embodiment or embodiments of the invention to overcome or at least partially mitigate the drawbacks of the prior art by providing a temperature control system which has a significantly reduced electrical consumption, in use.

### SUMMARY OF THE INVENTION

According to a first aspect of the present invention there is provided a temperature control system comprising: a compressor, a condenser, an expansion valve and an evaporator all connected in series by a plurality of refrigerant pipes; wherein the system further comprises an array of heat exchangers located between the compressor and the condenser operable in use to transfer heat energy from one or more external heat sources to the refrigerant leaving the compressor and before it enters the condenser.

Using heat exchangers to transfer heat energy to the refrigerant after leaving the compressor acts to heat up the refrigerant and in doing so increase the pressure of the refrigerant or increasing the mass flow into the evaporator and by so doing increasing the cooling capacity at the evaporator. As described above, both effects, increasing the pressure of the refrigerant and increasing the mass flow into the evaporator reduce the compression requirement of the compressor and hence reduces the energy consumption of the system as a whole. Providing an array of heat exchangers allows greater control over the extent of heat energy transferred to the refrigerant. This is particularly beneficial where the heat energy supplied by the external heat source cannot be controlled easily, for example where naturally occurring energy sources are used such as solar energy. The array of heat exchangers can be located at point between the compressor and the condenser which allows a greater flexibility in configuring the system. Furthermore, the size of the heat exchangers is not limited, allowing the system to be adapted for use with larger temperature control systems. The system is not limited to use with DC Inverter compressors of the type used in small air conditioner systems but can be adapted for use with fixed or variable speed compressors. This makes the system suitable for use in a wide range of temperature control applications including, but not limited to: air conditioning, chilling and refrigeration.

In some embodiments the temperature control system may additionally comprise one or more flow control members operable in use to direct the flow of the refrigerant such that it is either passed through at least one of the heat exchangers within the array or is passed directly from the compressor to the condenser, bypassing at least one of heat exchangers within the array. In further embodiments, the one or more flow control members are operable in use to direct the flow of refrigerant such that it is either passed through each heat exchanger or is passed directly from the compressor to the condenser, bypassing each heat exchanger. In further embodiments, the flow control members comprise a variable opening, which may or may not fully close, and which vary the flow-rate of the refrigerant. Each flow control member may comprise a valve.

Each heat exchanger may comprise a series of pipes containing a heated fluid (which may be a liquid or gas, and “fluid” hereinafter comprises either or both of a liquid or gas) over which the refrigerant is passed, in use. In this way, as the refrigerant passes over the pipes, heat energy is transferred from the fluid within the pipes of the heat exchanger to the refrigerant causing the refrigerant to heat up. The increase in temperature of the refrigerant causes the pressure to rise or the numbers of molecules to decrease (hence effecting an increase in mass flow means) as per Equation 1, above.

Alternatively, each heat exchanger may comprise a tank containing a heated fluid. In such embodiments, the refrigerant pipes of the system may be configured such that at least a portion of the pipes at the heat exchanger are submerged within that tank. Such embodiments work in a similar manner to that described above, wherein heat energy from the heated fluid within the tank is transferred to the refrigerant flowing through the pipes which are submerged within the tank.

At least two heat exchangers within the array may be located in series. Alternatively, at least two heat exchangers within the array may be located in parallel.

In some embodiments there is provided at least two heat exchangers in parallel and at least one further heat exchanger located in series with at least one of the heat exchangers which are in parallel to form the array of heat exchangers. In this way, by controlling the operation of each of the heat exchangers independently, the rate at which the refrigerant is heated by the heat exchangers in use may be varied.

In some embodiments each of the heat exchangers may be operable to transfer heat energy from a single heat source to the refrigerant. Alternatively, there may be provided a plurality of heat sources. In such embodiments, there may be provided a heat exchanger for each individual heat source. Alternatively, each heat source may act upon more than one heat exchanger.

The heat exchangers within the array may comprise one or more solar panels operable in use to use heat energy from sunlight to increase the temperature of a fluid within the panel, this heated fluid then acting as the heat exchanger to subsequently heat refrigerant passing through each exchanger. The solar panel may comprise a flat plate collector, for example, having a series of flow tubes through which the fluid flows or is located in a tank located underneath a collector plate which absorbs the heat energy from the sunlight.

Alternatively, the heat source may be any other external source able to heat up a fluid within each heat exchanger. In some embodiments, the heat source may provide heat energy through a combustion process. In such embodiments, the combustion process may give off hot gases which may be used to either directly or indirectly heat the refrigerant within the refrigerant pipes. In further embodiments the heat source may provide heat energy through a chemical process, such as an exothermic chemical reaction. Again, the chemical process may give off hot gases used to heat the refrigerant within the refrigerant pipes. In some embodiments the heat source may comprise a series of fuel cells and may heat the refrigerant through electrical heating. Alternatively, the heat source may be waste heat from one or more of the components of the system, which may be initially stored by the heat source, or may be used directly as it is produced by the system, in use. A further heat source may be water or other liquids heated up by solar thermal panels in a separate circuit, which may pass through the heat exchangers to heat up the refrigerant. This circuit may also contain a hot water storage tank which would allow the use of solar heat also in the absence of sunlight.

In some embodiments the compressor may comprise a first compressor and the system may additionally comprise one or more further compressors. Any further compressor may be located in series with the first compressor. Alternatively, each further compressor may be located in parallel with the first compressor. In some embodiments there is provided at least one further compressor in parallel with the first compressor and at least one further compressor located in series with the first compressor such that there is provided an array of compressors. In this way, by controlling the operation of each of the first compressor and the one or more further compressors, the rate at which the refrigerant is compressed in use may be varied.

In other embodiments, the rate at which the first compressor runs may be variable, removing the requirement to have one or more further compressors to vary the rate of compression of the refrigerant in use. However, in some embodiments it may still be desirable to have one or more further compressors in addition to the variable rate first compressor.

In some embodiments the system may comprise a plurality of evaporators. In use, the evaporators may be physically spaced apart so as to act to either cool or heat various different areas within an environment to be cooled/heated. In such embodiments, the system may additionally comprise a distributor operable to separate the refrigerant flow into a plurality of separate flows, at least one to each of the plurality of evaporators. The distributor may be placed directly after the condenser. In such embodiments, there may be provided an expansion valve for each of the evaporators. The system may additionally comprise a collector, operable in use to combine the plurality of separate flows from each of the evaporators back into a single main refrigerant flow.

In some embodiments the system may comprise a number of refrigerant pipes through which the refrigerant may flow, in use. At least two of the plurality of refrigerant pipes may be placed in parallel with each other in the system. In this way, the overall resistance within the system, or the resistance to the flow of the refrigerant around the system, or at least through the portion of the system comprising the parallel refrigerant pipes, is reduced as the effective heat transfer surface of the system is increased.

In some embodiments the system may comprise one or more valves. The one or more valves may be operable to control the flow of the refrigerant through the system, in use. In some embodiments at least one of the one or more valves may comprise a one-way valve. The/each one way valve may be operable in use to prevent refrigerant from flowing in an undesired direction. In some embodiments at least one of the one or more valves may comprise a stop valve. The/each stop valve may be operable in use to control the flow of refrigerant through the system in the desired direction. Such control may comprise controlling which components the refrigerant flows through and the flow rate at any given time. This may be desirable in embodiments wherein there is provided an array of compressors and it is required to control the compression rate of the refrigerant. Similarly, this may be desirable to control which of the heat exchangers the refrigerant is passed to control the extent to which the compressed refrigerant is heated.

In some embodiments at least one of the one or more valves comprises a security valve. The/each security valve may be operable in use to direct refrigerant within a given refrigerant pipe away from said pipe. In use, this may be desirable to ensure that there are no unwanted build-ups of pressure within a refrigerant pipe which may lead to the pipes becoming damaged or, in the worst case, rupturing. The/each security valve may be located after the heat exchanger array to prevent over pressurised refrigerant from the heat exchangers passing through the condenser and/or evaporator(s) and potentially causing damage thereto.

In some embodiments the temperature control system is operable in use to act as a cooling system, cooling the environment in which it is positioned. For example, the temperature control system may form part of a refrigerator or air-conditioning unit. Alternatively, the temperature control system is operable in use to act as a heating system, heating the environment in which it is positioned. For example, the temperature control system may form part of a heater, such as a convection heater.

In some embodiments the temperature control system may act as both a cooling system and a heating system at different times. For example, the temperature control system may form part of an air-conditioning unit or climate control unit which is operable in use to either heat or cool the environment in which it is placed to a pre-determined level. To allow for this, the system may comprise a four-way-valve operable in use to direct the flow of the refrigerant around the system in either of a first direction or a second direction. The first direction may comprise a cooling direction in which the refrigerant flows from the compressor, to the heat exchanger, to the condenser, through the expansion valve, on to the evaporator and back to the compressor. The second direction may comprise a cooling direction in which the refrigerant flows from the compressor, to the heat exchanger, to the evaporator, then through the expansion valve, on to the condenser and finally back to the compressor.

The system may additionally comprise a control unit. The control unit may be operable in use to control the operation of one or more of the components of the system, including the compressor, each heat exchanger, the condenser, the expansion valve and/or the evaporator. In relevant embodiments, the control unit may additionally or alternatively be operable to control the operation of the one or more further compressors, any of the plurality of evaporators and/or the operation of any of the one or more valves. For example, the control unit may control the rate at which the compressor acts to compress the refrigerant, and/or may control the flow of the refrigerant through the valves to each component.

In some embodiments, the system additionally comprises one or more sensors located within the refrigerant flow. The one or more sensors may be operable in use to monitor one or more parameters of the refrigerant, such as its temperature and/or pressure, at a certain point within the system. In some embodiments the sensors may be connected to the control unit. In such embodiments, the control unit may be operable to control the operation of one or more of the components of the system in response to the values of the parameters measured by the one or more sensors.

In some embodiments the system may be configured to prevent desegregation of the dispensed oil at unfavourable locations, and which may therefore cause a lack of oil supply to the compressor. For example, in embodiments in which each heat exchanger comprises U-pipes or conduits, each of the refrigerant pipes may be positioned such that the U-pipes in the heat exchangers are placed in an upper region so the oil may not desegregate and as such accumulate therein, which may cause blocking the pipe against the refrigerant to flow through. Additionally the pipes to and from the U-pipes may extend downwardly, such that oil may flow down by gravity and be collected in containers, from where it may be transported to the compressor.

The system may additionally comprise a means to segregate and/or dispense oil or other liquid components to the refrigerant. It may be necessary to make sure that enough oil is provided to the compressor and not retained in other locations in the overall pipework to ensure that each component of the system is operating correctly. For example, the oil or other fluid may be required by the compressor to lubricate the compressor, but not in the pipework and/or U-bends of the heat exchanger. The segregation process means this may comprise a separator for segregation and/or a trap for collecting the oil or fluid. In some embodiments, the separator and trap may be located ahead of the heat exchanger array or in it. In this way, the system ensures that the oil is recovered before it flows through the heat exchanger where it would not be wanted and then would be returned to the compressor.

According to a second aspect of the present invention there is provided a temperature control system comprising: a compressor, a condenser, an expansion valve and an evaporator, all connected in series by a plurality of refrigerant pipes; one or more heat exchangers located between the compressor and the condenser operable in use to transfer heat energy from one or more external heat sources to the refrigerant leaving the compressor and before it enters the condenser; and one or more flow control members operable in use to direct the flow of the refrigerant such that it is either passed through at least one of the one or more heat exchangers or is passed directly from the compressor to the condenser, bypassing at least one of the one or more heat exchangers.

In some embodiments the refrigerant may be passed at a full rate through at least one of the, or each, heat exchanger.

In some embodiments the refrigerant may be passed at a variable rate through at least one of the, or each, heat exchanger.

In some embodiments the system comprises a single heat exchanger. In such embodiments the one or more flow control members may be operable in use to direct the flow of the refrigerant such that it is either passed through the single heat exchanger or is passed directly from the compressor to the condenser, bypassing the single heat exchanger.

The second aspect of the present invention incorporates any or all of the features of the first aspect of the invention as is desired or appropriate. For example, in some embodiments, the temperature control system of the second aspect of the invention may comprise an array of heat exchangers. The array of heat exchangers may comprise any or all of the features of the array of heat exchangers of the first aspect of the invention. Similarly, in some embodiments the one or more flow control members of the system of the second aspect of the invention may comprise any or all of the features of the one or more flow control members of the first aspect of the invention.

In some embodiments the temperature control system may act as both a cooling system and a heating system at different times. To allow for this, the system may comprise a four-way-valve operable in use to direct the flow of the refrigerant around the system in either of a first direction or a second direction. The first direction may comprise a cooling direction in which the refrigerant flows from the compressor, to the heat exchanger, to the condenser, through the expansion valve, on to the evaporator and back to the compressor. The second direction may comprise a cooling direction in which the refrigerant flows from the compressor, to the heat exchanger, to the evaporator, then through the expansion valve, on to the condenser and finally back to the compressor.

In embodiments wherein the temperature control system may act as both a heating and cooling system, the one or more flow control members may be operable in use to direct the flow of the refrigerant such that it is passed through at least one of the one or more heat exchangers when the system is used as a cooling system. On the other hand, where the system is used as a heating system, the one or more flow control members may be operable in use to direct the flow of the refrigerant such that it is either passed through at least one of the one or more heat exchangers or is passed directly from the compressor to the condenser, bypassing at least one of the one or more heat exchangers.

According to a third aspect of the present invention there is provided a method of cooling an environment using a system in accordance with the first or second aspect of the present invention comprising the steps of:
(a) using the compressor to compress or heat a refrigerant;
(b) increasing the temperature of the compressed refrigerant by passing the refrigerant through one or more heat exchangers which transfer heat energy to the refrigerant from one or more external heat sources;
(c) condensing the heated refrigerant by passing the refrigerant through a condenser; and
(d) evaporating the condensed refrigerant by passing the refrigerant through an evaporator;

wherein evaporating the condensed refrigerant comprises passing air, gas or another fluid from the environment over the evaporator to transfer heat energy within the fluid to the condensed refrigerant thereby reducing the temperature of the fluid passed over the evaporator which is subsequently supplied back to the environment to be cooled.

According to a fourth aspect of the present invention there is provided a method of heating an environment using a system in accordance with the first or second aspect of the present invention comprising the steps of:
(a) using the compressor to compress or heat a refrigerant;
(b) increasing the temperature of the compressed refrigerant by passing the refrigerant through one or more heat exchangers which transfer heat energy to the refrigerant from one or more external heat sources;
(c) passing the heated refrigerant through an evaporator; and
(d) condensing the refrigerant leaving the evaporator by passing the refrigerant through a condenser;

wherein passing the heated refrigerant through the evaporator further comprises passing air or another fluid from the environment over the evaporator to transfer heat energy within the refrigerant to the fluid refrigerant thereby increasing the temperature of the fluid passed over the evaporator which is subsequently supplied back to the environment to be heated.

The method of the third or fourth aspects of the present invention may comprise passing the refrigerant over one or more heat exchangers which comprise a series of pipes having a heated fluid located therein. Alternatively, either method may comprise passing the refrigerant through one or more heat exchangers which comprise a tank containing a heated fluid. In both cases, heat energy from the heated fluid is transferred to the refrigerant.

Either method may comprise controlling the operation of the/each heat exchanger independently. In this way, the rate at which the refrigerant is heated by the heat exchanger/s may be varied.

In embodiments of either method the refrigerant may be heated using a heat source which provides heat energy through a combustion process. In such embodiments, the combustion process may give off hot gases which may be used to either directly or indirectly heat the refrigerant within the refrigerant pipes. In further embodiments the refrigerant may be heated using a heat source which provides heat energy through a chemical process, such as an exothermic chemical reaction. Again, the chemical process may give off hot gases used to heat the refrigerant within the refrigerant pipes. In some embodiments the heat source may comprise a series of fuel cells and the refrigerant may be heated through electrical heating. Alternatively, the refrigerant may be heated using a heat source which provides heat energy from waste heat from one or more of the components of the system, which may be initially stored by the heat source, or may be used directly as it is produced by the system. A further heat source may be water or other liquids which may be heated by solar thermal panels in a separate circuit, which is passed through the heat exchangers to heat up the refrigerant. This circuit may also contain a hot water storage tank which would allow the use of solar heat in the absence of sunlight.

The method of the third or fourth aspect of the invention may be performed using a system comprising a plurality of compressors, the method comprising independently controlling the operation of each of the compressors. In this way, the rate at which the refrigerant is compressed in use may be varied. In other embodiments, such as those wherein the system comprises only a single compressor, the method may comprise varying the rate at which the single compressor runs.

The method of the third or fourth aspects of the present invention may comprise controlling the temperature at more than one location within an environment. In such embodiments the method may be performed using a system comprising a plurality of evaporators.

The method of the third or fourth aspect of the invention may comprise using one or more valves to control the flow of the refrigerant through the system. In some embodiments at least one of the one or more valves may comprise a one-way valve, or may comprise a stop valve, for example. In such embodiments, the method may comprise controlling which components the refrigerant flows through at any given time. This may be desirable in embodiments wherein there is provided an array of compressors and it is required to control the compression rate of the refrigerant. Similarly, this may be desirable to control which of the one or more heat exchangers the refrigerant is passed through to control the extent to which the compressed refrigerant is heated.

In some embodiments of the third or fourth aspects of the invention, the method comprises using a security valve to direct refrigerant within a given refrigerant pipe away from said pipe. This may be desirable to ensure that there are no unwanted build-ups of pressure within a refrigerant pipe which may lead to the pipes becoming damaged or, in the worst case, rupturing. In some embodiments, the method may comprise using a security valve to prevent over pressurised refrigerant from at least one of the one or more heat exchangers passing through the condenser and/or evaporator/s and potentially causing damage thereto.

The method of either of the third or fourth aspects of the invention may comprise using a control unit to control the operation of one or more of the components of the system, including the compressor, the/each heat exchanger, the condenser, the expansion valve and/or the evaporator. In relevant embodiments, the method may also comprise using a control unit, either additionally or alternatively, to control the operation of the one or more further compressors, any of the plurality of evaporators and/or the operation of any of the one or more valves. For example, the method may comprise using the control unit to control the rate at which the compressor acts to compress the refrigerant, and/or control the flow of the refrigerant through the valves to each component.

In some embodiments of the third or fourth aspects of the invention the method may comprise monitoring one or more parameters of the refrigerant, such as its temperature and/or pressure. In such embodiments, the method may comprise using one or more sensors located within the refrigerant flow to monitor said parameters. In some embodiments, the operation of one or more of the components of the system in response to the values of the parameters measured by the one or more sensors. The method may comprise using a control system in communication with the sensor/s to monitor and subsequently control the operation of the system.

The methods of the third or fourth aspects of the invention may comprise segregating oil or other fluids from, or dispensing oil or other fluids to, the refrigerant. It may be necessary to segregate oil or other fluids from the refrigerant at specific locations to prevent them travelling to unfavourable locations within the circuit to ensure that each component of the system is operating correctly and the oil is returned to the compressor in sufficient amounts to ensure its sufficient lubrication.

According to a further aspect of the invention, there is provided a temperature control system comprising: a compressor, a condenser, an expansion valve and an evaporator all connected in series by a plurality of refrigerant pipes; wherein the system further comprises a plurality of heat exchangers operable in use to transfer heat energy from external heat sources to the refrigerant, wherein at least two of the heat exchangers are configured to transfer heat energy from different external heat sources.

In an embodiment, at least one of the heat exchangers is located between the compressor and the condenser to transfer heat from an external heat source into the refrigerant leaving the compressor and before it enters the condenser. In an embodiment, all of the heat exchangers are located between the compressor and the condenser to transfer heat from external heat sources into the refrigerant leaving the compressor and before it enters the condenser, in which case, the heat exchangers may be arranged in an array.

The external heat sources may comprise any two or more of the following: solar energy, combustion processes, chemical processes, electrical heaters, fuel cells, geothermal energy, waste heat from one or more of the components of the system.

According to a still further aspect of the invention, there is provided a temperature control system comprising: a compressor, a condenser, an expansion valve and an evaporator all connected in series by a plurality of refrigerant pipes; wherein the compressor includes a first compressor and one or more further compressors. The/each further compressor may be located in series with the first compressor, or may be located in parallel with the first compressor. In an embodiment, at least one further compressor is connected in parallel with the first compressor and at least one further compressor is connected in series with the first compressor such that there is provided an array of compressors. The rate at which each compressor runs may be variable. In an embodiment, operation of all the compressors is controlled by a single control unit.

According to a yet further aspect of the invention, there is provided a temperature control system comprising: a compressor, a condenser, an expansion valve and an evaporator all connected in series by a plurality of refrigerant pipes; wherein the system comprises a means to segregate oil or other added components from the refrigerant to collect and supply it to other desired locations at the circuit. In an embodiment, the segregation means comprises a separator and/or an oil-trap which may be located ahead of the one or more heat exchangers or after the one or more heat exchangers or within the heat exchangers. The separator and/or the oil trap may be connected to the compressor by an oil supply line. Where an oil trap is present, it may be a U-bend in the refrigerant pipeline.

### DETAILED DESCRIPTION OF THE INVENTION

In order for the invention to be more clearly understood, embodiments thereof will now be described, by way of example only, with reference to the accompanying drawings, of which:

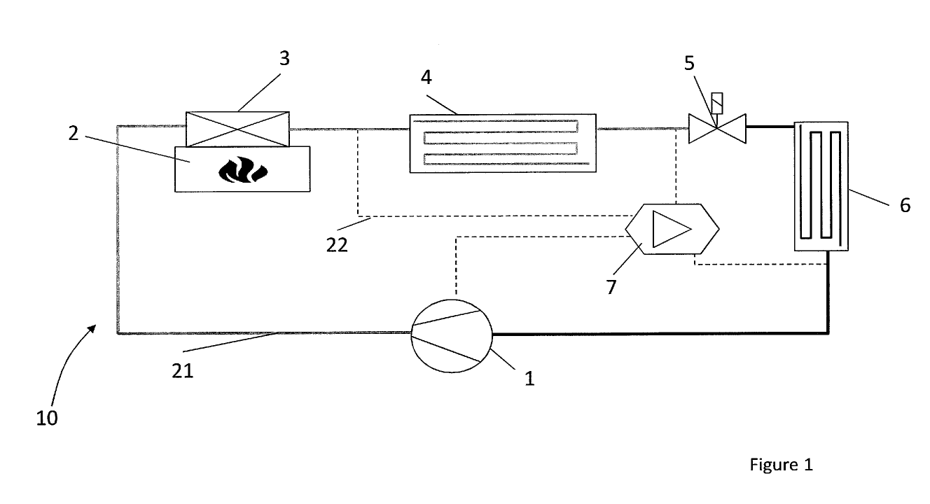

FIG. 1 is a schematic view of a temperature control system.

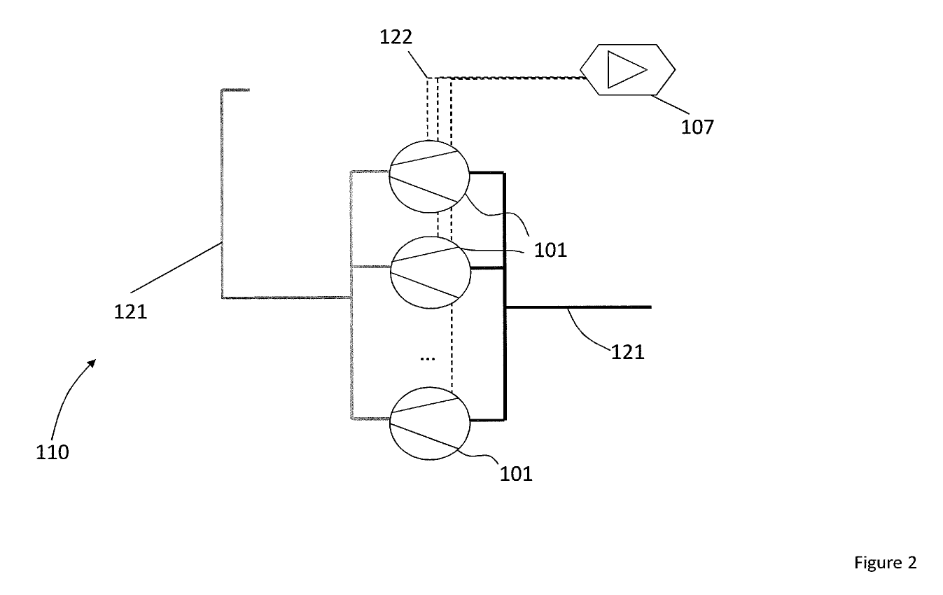

FIG. 2 is a schematic view of an embodiment of a temperature control system of the present invention.

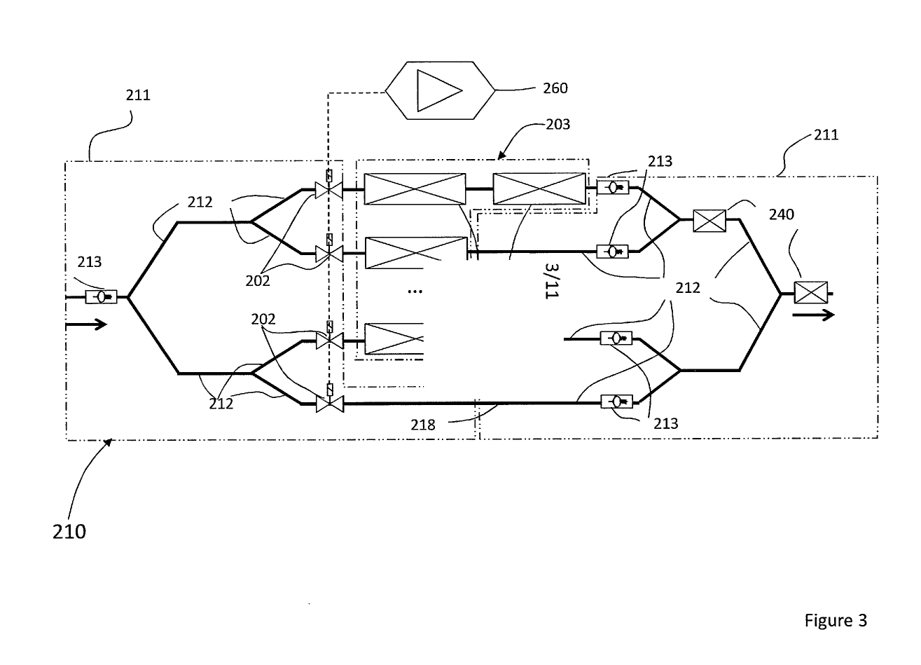

FIG. 3 is a schematic view of a second embodiment of a temperature control system of the present invention.

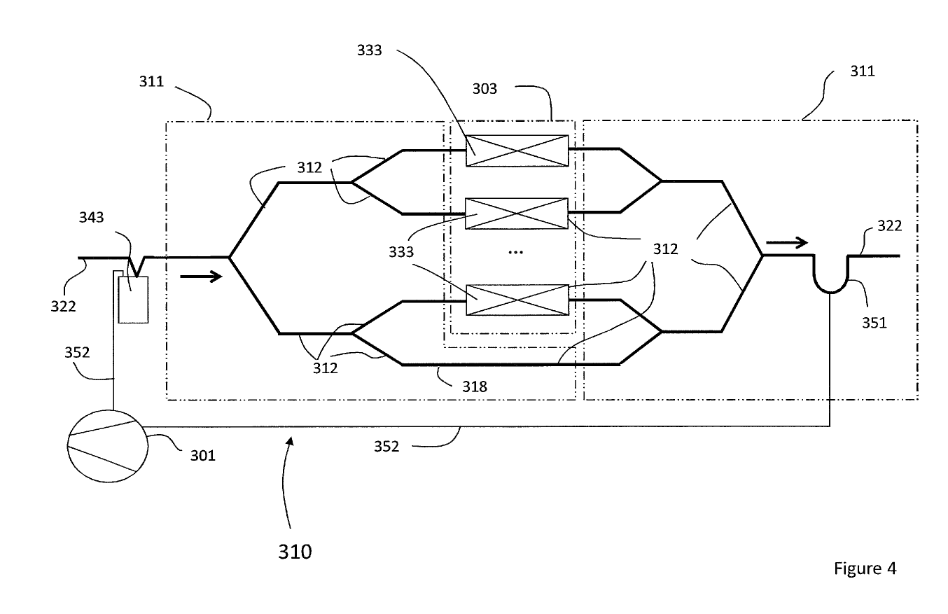

FIG. 4 is a schematic view of a third embodiment of a temperature control system of the present invention.

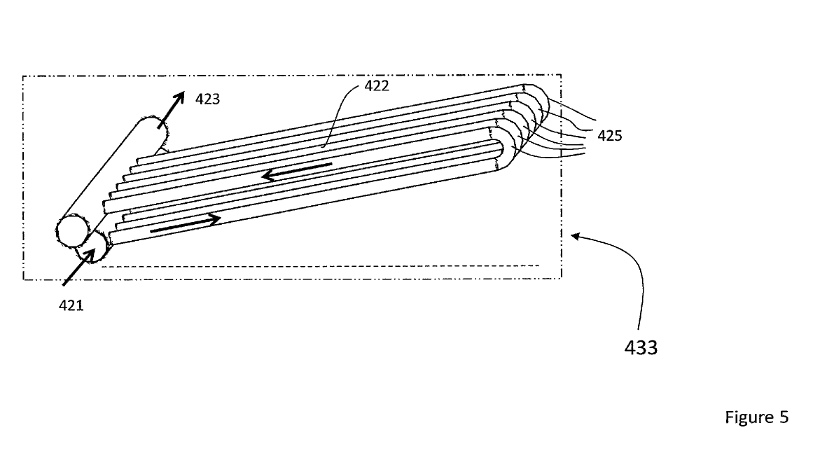

FIG. 5 is a perspective view of an embodiment of a heat exchanger for use in a temperature control system in accordance with the present invention.

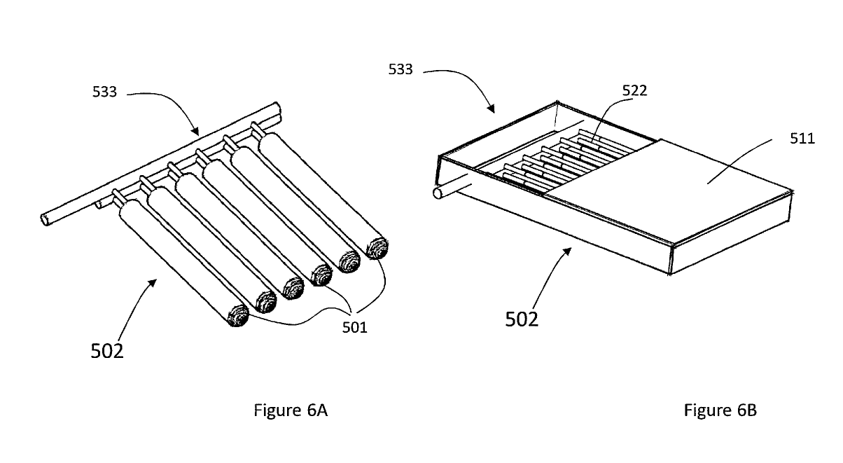

FIG. 6A is a perspective view of a heat source for use in a temperature control system of the present invention.

FIG. 6B is a further perspective view of the heat source shown in FIG. 6A.

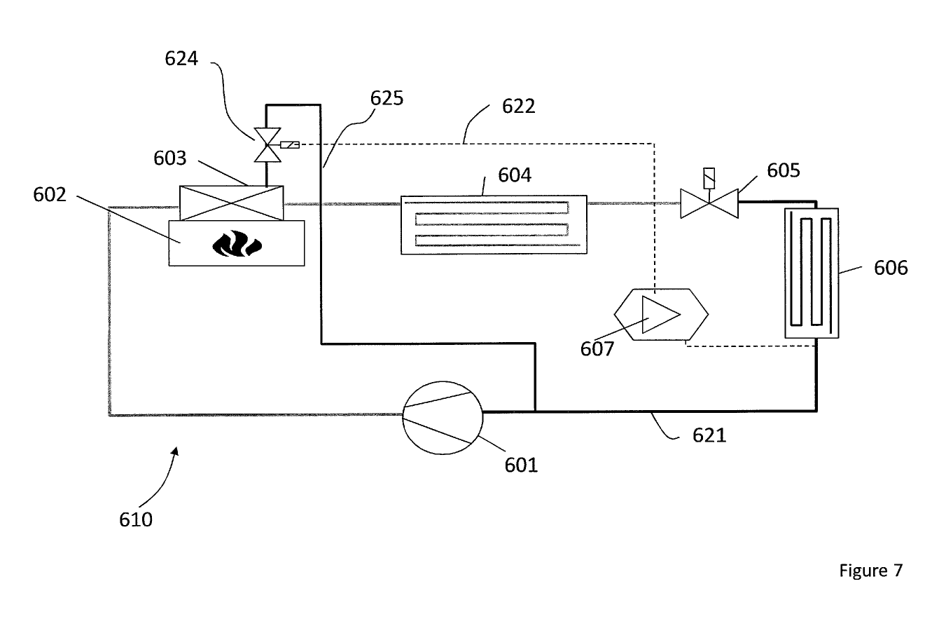

FIG. 7 is a schematic view of a fourth embodiment of a temperature control system of the present invention.

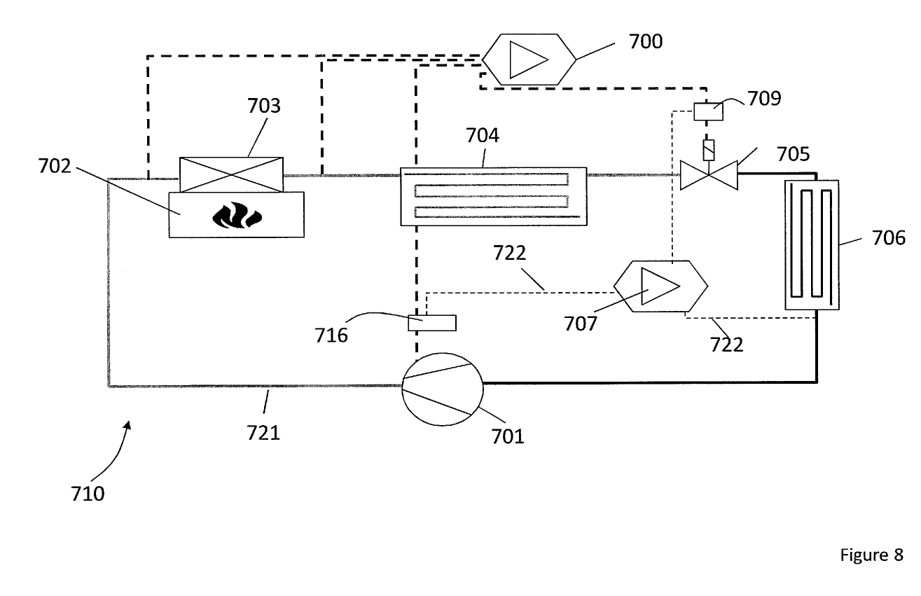

FIG. 8 is a schematic view of a fifth embodiment of a temperature control system of the present invention.

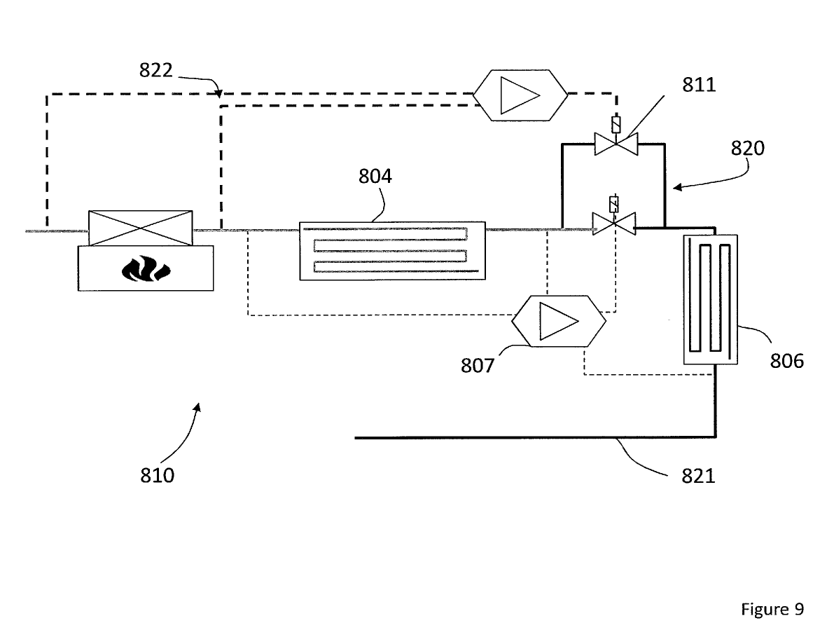

FIG. 9 is a schematic view of a sixth embodiment of a temperature control system of the present invention.

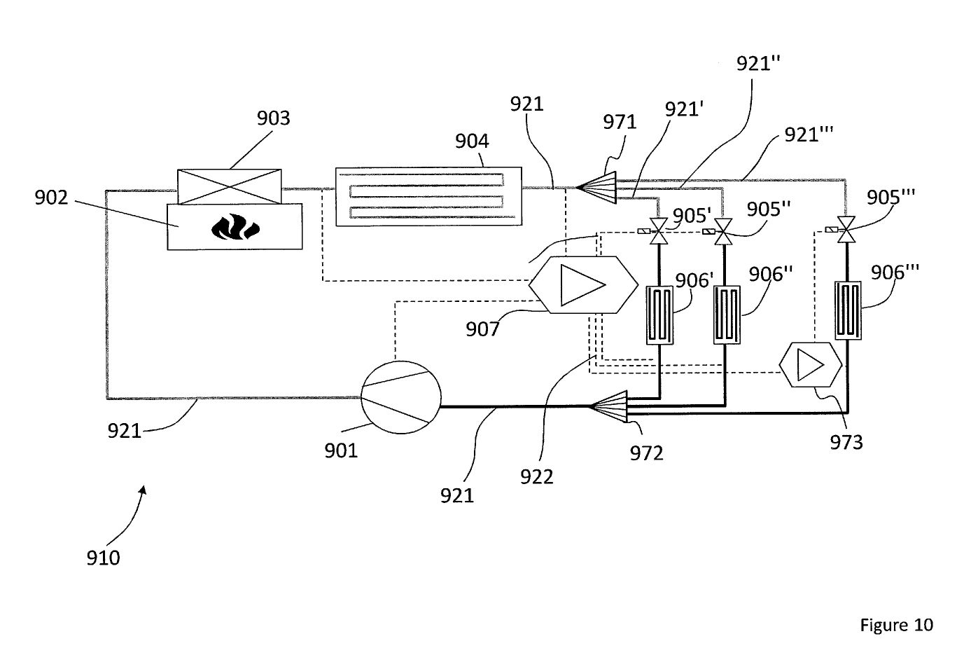

FIG. 10 is a schematic view of a seventh embodiment of a temperature control system of the present invention.

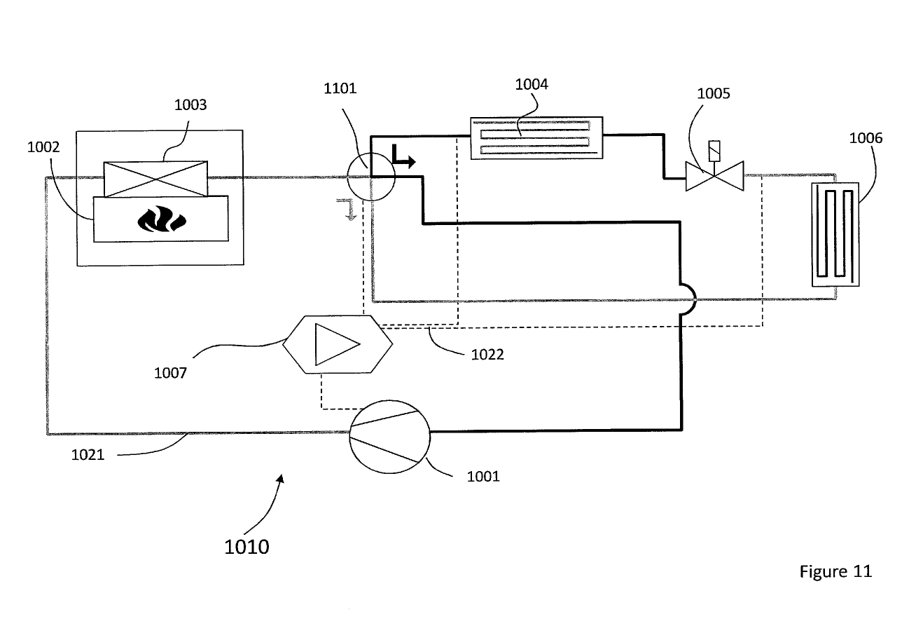

FIG. 11 is a schematic view of an eighth embodiment of a temperature control system of the present invention.

FIG. 1 illustrates a temperature control system 10. The system 10 includes a compressor 1, a condenser 4, an expansion valve 5 and an evaporator 6, each connected by a number of refrigerant lines 21 to form a compression circle. The system 10 additionally includes a heat exchanger 3 located within the circle between the compressor 1 and the condenser 4. The heat exchanger 3 is operable to obtain heat energy from an external heat source, references as heat source 2 on FIG. 1. To control the operation of the system 10, the system also includes a control unit 7 which is electrically connected to each of the components of the compression circle via signal lines 22 to control the operation of the components in use.

In use, the compressor 1 acts to compress a refrigerant, which may be any fluid and most preferably a gas, as it passes there-through and discharges it through the refrigerant pipes to the heat exchanger 3. The heat exchanger 3 transfers heat which is obtained through interaction with the heat source 2 with the refrigerant, resulting in the refrigerant increasing in temperature. The heated refrigerant is then passed through the condenser 4 and subsequently through the expansion valve 5 and towards the evaporator 6. When passing through the expansion valve 5 the refrigerant expands and in doing so cools down rapidly. The cool refrigerant is then passed through the evaporator 6 where it is heated by absorbing heat energy from the surroundings of the evaporator 6. As the refrigerant is heated in this manner, the temperature of the surroundings reduces. The heated refrigerant is then passed back through the compressor 1 to restart the process.

As the refrigerant is preferably a gaseous fluid, its physical state may be approximated using the ideal gas law (see above for detail) which states that the product of the pressure of the gas and the volume within which the gas is contained is proportional to the product of the number of molecules of gas present and the temperature of the gas. In effect, in environments wherein the volume remains constant, such as in the refrigerant pipes of a temperature control system, an increase in temperature may have two positive effects depending on the opening of the subsequent expansion valve.

The temperature control system 10 makes use of this fact by utilising a heat exchanger 3 and an external heat source 2 to heat the refrigerant further after the refrigerant has been passed through the compressor 1. By increasing the temperature of the refrigerant in this way, and approximating both the volume and the number of molecules of gas present within the volume to be roughly constant, because the expansion valve is closed, an increase in temperature leads to an increase in pressure also. The desired pressure is usually achieved in prior art systems through the compressor 1 alone, however, by additionally heating the refrigerant as in the present invention, you can achieve the desired pressure without the need for the compressor to perform all of the work. When the expansion valve is opened, the molecules of the heated gas will have a much higher tendency to pass through the expansion valve, because there is a very large pressure difference between before and after the expansion valve, as to build up additional pressure. This increased mass flow means that more refrigerant molecules are now in the evaporator as without the heating effect and so causing a higher cooling capacity in the evaporator. The control of the overall air conditioner reacts to the increase by reducing the mass flow of the compressor to re-achieve the original targeted cooling capacity. Both effects, the pressure increase and mass flow increase, reduce the electrical consumption of the compressor. The rate of which depends on the very specific situation, if and how much the expansion valve is opened at the operation of which changes within seconds. Therefore, by employing a heat exchanger 3 in this way, the efficiency of the compression process of the compression circle is increased as the compressor now requires less energy to provide the same cooling capacity as in systems wherein there is no heat exchanger provided.

Many different types of heat sources 2 may be used. For example, the heat source 2 may comprise one or more combustion engines, chemical processes, electrical heaters, fuel cells, or solar thermal heat sources like solar thermal panels. In the embodiment illustrated in FIG. 6A, the heat source 502 comprises a series of vacuum glass tubes 501, whereas in the embodiment shown in FIG. 6B the heat source 502 comprises a flat glass pane 511 having an absorption layer 522 underneath and above a series of pipes. In both instances, the heat sources 502 are operable to absorb heat from solar radiation. This heat is transferred to a fluid running through or sitting in the glass tubes 502 or the pipes 522 and is used to increase the temperature of the refrigerant by passing the heat from the fluid over/around the pipes in a the heat exchanger 533 through which the refrigerant flows.

The heat exchanger 3 as shown in FIG. 1 must be dimensioned large enough to be effective, but not too large to harm the performance and/or components of the control system 10. The total amount of heat transferred by a heat exchanger to the refrigerant is defined by the size of the exchanger, but also by the number of heat exchangers used. Therefore, the temperature control system in accordance with some embodiments of the present invention employs an array of heat exchangers. Increasing the number of heat exchangers increases the heating capacity of the system but also provides greater control over the extent to which the refrigerant is heated, in use. In further embodiments, the system of the present invention may employ one or more heat exchangers, or an array of heat exchangers, and a means to control through which of the one or more heat exchangers present in the system the refrigerant is passed. This again provides greater control over the heating of the compressed refrigerant in use. Such systems are described in detail below.

Such an embodiment of a temperature control system 210 of the present invention, wherein a heat exchanger array 203 comprising a series of heat exchangers 233 is used, is shown in FIG. 3. The system 210 illustrated in FIG. 3 comprises a series of heat exchangers 233 connected by various refrigerant lines 212, 218, defined as pipework 211 in the drawing. The pipework 211 also includes a series of one-way valves 213 located after each heat exchanger 233 within the array 203 to prevent back-flow of refrigerant through the system 210. A similar one-way-valve 213 may be located before the array 203 to perform a similar function. In addition, the system 210 further includes a series of electronically activated valves 202 located immediately before each of the heat exchangers 233 within the heat exchanger array 203. The operation of the valves 202 is controlled by a control unit 260. In this way, the heat transferred to the refrigerant may be controlled in a variable way. Additional heat exchangers 240 may also be employed, as shown in FIG. 3, downstream of the one-way valves 213. The system 210 shown in FIG. 3 illustrates one example of a heat exchanger array 203. However, it should be understood that many different configurations of the array are possible and it is not limited to the configuration shown in this Figure.

FIG. 2 shows a variant of the preceding systems 10, 210 shown in FIG. 1. In particular, the system 110 shown in FIG. 2 employs a series of compressors 101, the operation of which is controlled by a single control unit 107. Employing a series of compressors 101 in this way increases the compression effect on the refrigerant further.

FIG. 4 shows part of a further embodiment of a temperature control system 310 of the invention which also includes a heat exchanger array 303 having multiple heat exchangers 333. In addition, the pipework 311 pipework and heat exchangers 333 are constructed in such a way that oil and other liquid components may be segregated from the refrigerant as desired. Such components may be then transported to the desired locations to increase the durability of components and pipework 311. To enable this, the illustrated embodiment includes an oil separator 343 which is connected to both the refrigerant line 322 and also via an oil supply line 352 to the compressor 301. Similarly, the refrigerant line 312 is configured at a point downstream of the heat exchanger array 303 to include an oil trap 351. This may be formed as a U-bend in the refrigerant line 312 to segregate and accumulate oil from within the refrigerant line 322. The oil trap 351 may also be connected to the compressor 301 as shown.

FIGS. 3 and 4 also illustrate a further feature of the present invention. In particular, the systems 210, 310 shown in these Figures include respective refrigerant lines 218, 318 which bypass one or more heat exchangers 233, 333 within the heat exchanger array 203, 303. In use, it may be desirable for the refrigerant within the systems 210, 310 not to pass through a heat exchanger 233, 333, but rather pass directly to the condenser after compression. Such cases may be desirable where heating of the compressed refrigerant is not required or not desired. The electronically activated valves 202, 302 shown in these Figures may in some embodiments form the flow control members of an aspect of the invention. The valves 202, 302 may be switched to either allow the refrigerant to pass fully or at variable rate through at least one of the one or more heat exchangers and/or allow the refrigerant to be passed directly from the compressor to the condenser, bypassing at least one of the one or more heat exchangers.

It should be understood that, although illustrated as comprising a plurality of heat exchangers, the system of the present invention also includes embodiments wherein there is provided a single heat exchanger and a means to bypass the sole heat exchanger.

An embodiment of a heat exchanger 433 is shown in FIG. 5 and may be used in a temperature control system such as that shown in FIG. 4 which includes additional means to segregate oil and other liquids from within the refrigerant pipes preventing an accumulation at undesired places and supplying it to the desired locations in the pipework. The heat exchanger 433 includes manifolds 421, 423 and one or more U-bends 425 in its refrigerant pipes 422. The pipes 422 may be configured in this way to provide the maximum length of pipe 422 in the smallest space possible.

In use, the heat exchanger 433 may be positioned so that the U-bends 425 are placed higher than the manifolds 421, 423. This is particularly advantageous when the heat exchanger is used in a temperature control system such as that shown in FIG. 4 which includes additional means to return oil and other liquids from within the refrigerant pipes. By positioning the pipes 422 in this manner, it allows oil and other liquids within the refrigerant to flow back from the U-bends 425 into the manifolds 421, 423 and then onward to the designated components in the cooling circle. In this way, the oil or other liquid is prevented from blocking the mass flow in the U-bends and flowing back in the above described manner to be collected and transported to the other desired locations in the pipework.

Further embodiments of the temperature control system of the present invention are shown in FIGS. 7 to 11. Each of the systems illustrated in these figures operate in a substantially similar way however the differences, and the operational effect of these differences, are described in detail below. The systems also contain certain components which are common to all of the systems and so like reference numerals have been used to identify like components in each system. In the Figures, the array of heat exchangers is depicted by a single component, however, it should be understood that the single component is intended to be a heat exchanger array as in the above illustrated embodiments of the present invention.

The temperature control system 610 illustrated in FIG. 7 further includes a security valve 624 being connected to the manifold of a heat exchanger array 603. The valve 624 is connected to a relief pipe 625 which itself then leads into the refrigerant line 621 after the evaporator 606 and ahead of the compressor 601. The valve 624 may be mechanically and/or electronically activated and may be operable in use to release refrigerant exceeding the critical pressure in the heat exchanger array 603 into the relief pipe 625 prior to entering the compressor 601. This prevents an unwanted excess pressure within the heat exchanger array 603 itself, and also prevents over-pressurised refrigerant from exiting the heat exchanger array 603 and passing to the condenser 604.

FIG. 8 demonstrates a further embodiment of a temperature control system 710 in which the expansion valve 705 and/or compressor 701 are connected to a central control unit 700 by a series of signal transmission lines 722. The control unit 700 is operable to control the operation of the valve 705 and/or the compressor 701 to override the signals and commands as given by the original central control unit 707 of the system 710. This is beneficial as it allows additional control over these components with the aim to avoid faults in the performance of these components. The system 710 may additionally include temperature and/or pressure sensors (not shown) within the refrigerant lines 721 or components of the system 710 which are connected to the logic controller 700 to provide data thereto. This data may in turn be interpreted by the controller 700 which may control the operation of the compressor 701 and or the expansion valve 705 based on the data provided by the sensors within the refrigerant lines 721.

FIG. 9 shows a further embodiment of a temperature control system 810 which additionally includes a bypass branch 820 which is connected to refrigerant lines 821 and has a separate electrically activated expansion valve 811. The expansion valve 811 simply provides an additional route for the refrigerant to be passed through towards the evaporator giving increased control over the flow of the refrigerant through the system 810. The expansion valve 811 is in turn connected to a logic controller 800 (which is substantially identical to the logic controller 700 shown in FIG. 8 and performs a similar function) which also controls the flow of the refrigerant parallel through the additional expansion valve 811.

FIG. 10 shows a further embodiment of a temperature control system 910. The system 910 is substantially similar to other above described systems, however the refrigerant lines 921 after having left the condenser 904 are split into various sub-circles using a distributor 971, with each sub-circle having an individual expansion valve 905, an evaporator 906 and connecting refrigerant lines 921. Each of the refrigerant lines 921 may also include temperature and/or pressure sensors which are in turn connected to the control unit 907 and/or a sub-control unit 973 being itself connected to the central control unit 907 for monitoring and controlling the flow of refrigerant through the lines 921 and indeed the temperature control process as a whole and also within in the individual sub-circles. The refrigerant lines 921 of the individual sub-circles come together in a collector 972 and from then in a common refrigerant line 921 to the compressor 901. By providing multiple evaporators 906, the system 910 can provide temperature control in a number of different spatial locations. For example, in different positions within a single area, or indeed within separate areas within an environment such as different rooms within a property.

FIG. 11 shows a further embodiment of a temperature control system 1010 of the present invention. The system 1010 differs from the above-described embodiments in that it further includes a means to reverse the direction of refrigerant flow through part of the system 1010 to enable the system 1010 to be used as both a cooling and heating system. To achieve this, the system 1010 includes an additional four-way-valve 1101 being connected to a series of refrigerant lines 1021 and also to a central control unit 1007 through transmission lines 1022 for control of the valve 1101. The refrigerant lines 1021 connect the four-way-valve 1101 with a heat exchanger array 1003, a condenser 1004, an evaporator 1006 and a compressor 1001. The four-way-valve 1101 is operable to configure the refrigerant to flow through the system 1010 in one of two separate directions. The first being where the refrigerant flows through the pipes 1021 from the heat exchanger 1003 to the condenser 1004, then to the expansion valve 1005, then to the evaporator 1006 and finally back to the four-way-valve 1101 then to the compressor 1001. In this setup, the system 1010 acts as a cooling system as the condensed refrigerant is passed through the evaporator leading to the refrigerant heating up by removing heat energy from its surroundings. Alternatively, the four-way-valve may direct the refrigerant through the system 1010 from the heat exchanger array 1003 to the evaporator 1006, then to the expansion valve 1005, then to the condenser 1004, then back to the 4-way valve 1101 and on to the compressor 1001. In this setup, the refrigerant is heated and pressurised as it enters the evaporator 1006, where it subsequently cools as the refrigerant transfers heat to the surrounds. In the heating configuration, the heat exchanger array 1003 acts to heat up the gas further after the compressor 1001 which is then transferred in the evaporator 1006 as described above. The more the heat exchanger array 1003 adds heat to the refrigerant after the compressor 1001, the less the compressor 1001 must heat up the refrigerant. Ideally the compressor 1001 only moves the refrigerant forward while the heat exchanger array 1003 takes over the heating requirements. The setting of the four-way-valve 1101 and so the distinction between cooling or heating operation is set by the central control unit 1007 and may be based on the user's requirements and/or measured temperatures and/or pressures at sensors located within the refrigerant lines 1021 in the cooling circle or its components.

Similarly, where the temperature control system may act as both a heating and cooling system, such as in the system 1010 shown in FIG. 11, the system 1010 may additionally include one or more flow control members, which may be in the form of valves, which are operable in use to direct the flow of the refrigerant such that it is either passed through at least one of the one or more heat exchangers or is passed directly from the compressor to the condenser, bypassing at least one of the one or more heat exchangers. The bypassing of the one or more heat exchangers may be performed using an arrangement similar or equivalent to that shown in FIGS. 3 and 4, which comprise an additional refrigerant line which takes refrigerant directly from the compressor to the condenser without passing through a heat exchanger. In embodiments wherein the system 1010 is used as a cooling system, it may be desirable that all of the refrigerant is passed through at least one heat exchanger. Therefore, in such cases, the flow control members, or valves, may operate to direct the refrigerant in this way. Alternatively, where the system 1010 is used as a heating system, it may be desirable for at least some of the refrigerant not to pass through a heat exchanger. Therefore, in these instances, the flow control members, or valves, may operate to direct at last some of the refrigerant such that it bypasses the/each heat exchanger.

The above embodiments are described by way of example only. Many variations are possible without departing from the scope of the invention as defined in the appended claims.

1. A temperature control system comprising: a compressor, a condenser, an expansion valve and an evaporator all connected in series by a plurality of refrigerant pipes; wherein the system further comprises an array of heat exchangers located between the compressor and the condenser operable in use to transfer heat energy from one or more external heat sources to the refrigerant leaving the compressor and before it enters the condenser.

2. A temperature control system as claimed in claim 1 comprising one or more flow control members operable in use to direct the flow of the refrigerant such that it is either passed through at least one of the heat exchangers within the array or is passed directly from the compressor to the condenser, bypassing at least one of heat exchangers within the array.

3. A temperature control system comprising: a compressor, a condenser, an expansion valve and an evaporator, all connected in series by a plurality of refrigerant pipes; one or more heat exchangers located between the compressor and the condenser operable in use to transfer heat energy from one or more external heat sources to the refrigerant leaving the compressor and before it enters the condenser; and one or more flow control members operable in use to direct the flow of the refrigerant such that it is either passed through at least one of the one or more heat exchangers or is passed directly from the compressor to the condenser, bypassing at least one of the one or more heat exchangers.

4. A temperature control system of claim 3 comprising an array of heat exchangers.

5. A temperature control system as claimed in claim 3 wherein the refrigerant is passed at a variable rate through at least one of the heat exchangers.

6. A temperature control system as claimed in claim 5 wherein the one or more flow control members are operable in use to direct the flow of refrigerant such that it is either passed through each heat exchanger or is passed directly from the compressor to the condenser, bypassing each heat exchanger.

7. A temperature control system of claim 6 wherein the/each flow control member comprises a valve.

8. A temperature control system of claim 7 wherein the/each heat exchanger comprises a series of pipes containing a heated fluid over which the refrigerant is passed, or comprises a tank containing a heated fluid and the refrigerant pipes of the system are configured such that at least a portion of the pipes at the heat exchanger are submerged within the tank containing the fluid.

9. A temperature control system of claim 8 which comprises an array of heat exchangers, wherein at least two heat exchangers within the array are located in series.

10. A temperature control system of claim 8 which comprises an array of heat exchangers, wherein at least two heat exchangers are located in parallel.

11. A temperature control system of claim 8 which comprises an array of heat exchangers wherein there is provided at least two heat exchangers in parallel and at least one further heat exchanger located in series with at least one of the heat exchangers which are in parallel to form the array of heat exchangers.

12. A temperature control system of claim 11 wherein each heat exchanger is operable to transfer heat energy from a single heat source to the refrigerant.

13. A temperature control system of claim 12 wherein there is provided a plurality of heat sources.

14. A temperature control system of claim 3 wherein the/each heat exchanger comprises one or more solar panels operable in use to use heat energy from sunlight to increase the temperature of a fluid within the panel, this heated fluid then acting as the heat exchanger to subsequently heat refrigerant passing through each exchanger.

15. A temperature control system of claim 14 wherein the/each solar panel comprises a flat plate collector having a series of tubes or tanks with a fluid flowing through or contained therein and located underneath a collector plate which absorbs the heat energy from the sunlight.

16. A temperature control system of claim 3 wherein the or each heat source is operable to provide heat energy through one of a combustion process, a chemical process, such as an exothermic chemical reaction, through waste heat from one or more of the components of the system or through a separate hot water/liquid circuit, where the water/liquid is heated up by solarthermal panels.

17. A temperature control system of claim 3 wherein the compressor comprises a first compressor and the system may additionally comprise one or more further compressors.

18. A temperature control system of claim 17 wherein the/each further compressor is be located in series with the first compressor, or is located in parallel with the first compressor.

19. A temperature control system of claim 17 wherein there is provided at least one further compressor in parallel with the first compressor and at least one further compressor located in series with the first compressor such that there is provided an array of compressors.

20. A temperature control system as claimed in claim 3 wherein the rate at which the/each compressor runs is variable.

21. A temperature control system of claim 3 comprising a plurality of evaporators.

22. A temperature control system of claim 3 comprising one or more valves operable to control the flow of the refrigerant through the system.

23. A temperature control system of claim 22 wherein at least one of the one or more valves comprises a one-way valve, or a stop valve.

24. A temperature control system of claim 23 wherein at least one of the one or more valves comprises a security valve operable in use to direct refrigerant within a given refrigerant pipe away from said pipe.

25. A temperature control system of claim 24 wherein the or each security valve is located after the heat exchanger(s) to prevent over pressurised refrigerant from the heat exchangers passing through the condenser and/or evaporator/s and potentially causing damage thereto.

26. A temperature control system of claim 3 operable in use to act as a cooling system, cooling the environment in which it is positioned.

27. A temperature control system of claim 26 operable in use to act as a heating system, heating the environment in which it is positioned.

28. A temperature control system of claim 27 comprising a four-way-valve operable in use to direct the flow of the refrigerant around the system in either of a first direction or a second direction, the first direction comprising a cooling direction and the second direction comprising a heating direction.

29. A temperature control system of claim 3 comprising a control unit operable in use to control the operation of one or more of the components of the system.

30. A temperature control system of claim 3 comprising one or more sensors operable in use to monitor one or more parameters of the refrigerant at a certain point within the system.

31. A temperature control system as claimed in claim 3 comprising a means to segregate oil or other added components from the refrigerant to collect and supply it to other desired locations at the circuit.

32. A temperature control system as claimed in claim 31 wherein the segregation comprise a separator and/or an oil-trap.

33. A temperature control system as claimed in claim 32 wherein the separator and oil-trap are located ahead of the one or more heat exchangers or after the one or more heat exchangers or within the heat exchangers.

34. A method of cooling an environment using a system as claimed in claim 33 comprising the steps of:
a. using the compressor to compress or heat a refrigerant;
b. increasing the temperature of the compressed refrigerant by passing the refrigerant through one or more of the heat exchangers which transfer(s) heat energy to the refrigerant from one or more external heat sources;
c. condensing the heated refrigerant by passing the refrigerant through a condenser; and
d. evaporating the condensed refrigerant by passing the refrigerant through an evaporator;
wherein evaporating the condensed refrigerant comprises passing air or gas or another fluid from the environment over the evaporator to transfer heat energy within the fluid to the condensed refrigerant thereby reducing the temperature of the fluid passed over the evaporator which is subsequently supplied back to the environment to be cooled.

35. A method of heating an environment using a system as claimed in claim 33 comprising the steps of:
a. using the compressor to compress or heat a refrigerant;
b. increasing the temperature of the compressed refrigerant by passing the refrigerant through one or more heat exchanger(s) which transfer heat energy to the refrigerant from one or more external heat sources;
c. passing the heated refrigerant through an evaporator; and
d. condensing the refrigerant leaving the evaporator by passing the refrigerant through a condenser;
wherein passing the heated refrigerant through the evaporator further comprises passing air or gas or another fluid from the environment over the evaporator to transfer heat energy within the refrigerant to the fluid refrigerant thereby increasing the temperature of the fluid passed over the evaporator which is subsequently supplied back to the environment to be heated.

36. A system or method substantially as described herein with reference to the accompanying drawings.
